(19) United States
(12) Patent Application Publication
(10) Pub. No.: US 2024/0039203 A1
(43) Pub. Date: Feb. 1, 2024

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Shinji TANAKA, Mie (JP)

(21) Appl. No.: 18/021,486

(22) PCT Filed: Jul. 29, 2021
(86) PCT No.: PCT/JP2021/028217

§ 371 Date: Feb. 15, 2023

(30) Foreign Application Priority Data
Aug. 31, 2020 (JP) 2020-145205

(51) Int. Cl. H01R 13/52

(52) U.S. Cl. CPC H01R 13/52

(57) ABSTRACT

It is aimed to provide a connector provided with a novel and useful waterproof structure. A connector (10) is provided with a first housing (21) including a fitting recess (24) and a second housing (61) to be fit into the fitting recess (24). Liquid-repellent uneven surfaces (100) are provided on an inner surface of the fitting recess (24) of the first housing (21) and an outer surface of the second housing (61) facing the inner surface.

### TECHNICAL FIELD

The present disclosure relates to a connector.

### BACKGROUND

A connector described in Patent Document 1 is provided with a housing and an annular packing to be assembled with the housing. The housing is fit into a fitting recess of a mating housing. The packing has a function of waterproofing the fitting recess of the mating housing and the housing.

### PRIOR ART DOCUMENT

### Patent Document

Patent Document 1: JP 2020-024824 A

### SUMMARY OF THE INVENTION

### Problem to be Solved

In the case of Patent Document 1, cost increases due to the packing and, in addition, a cumbersome operation of assembling the packing with the housing is necessary. In contrast, if the packing is omitted, there is a problem that the connector cannot be waterproofed.

Accordingly, the present disclosure aims to provide a connector provided with a novel and useful waterproof structure.

### Means to Solve the Problem

The present disclosure is directed to a connector with a first housing including a fitting recess and a second housing to be fit into the fitting recess, liquid-repellent uneven surfaces being provided on an inner surface of the fitting recess and an outer surface of the second housing facing the inner surface.

### Effect of the Invention

According to the present disclosure, it is possible to provide a connector provided with a novel and useful waterproof structure.

### BRIEF DESCRIPTION OF THE DRAWINGS

FIG. 1 is a section showing a state where a first connector and a second connector are connected in a connector of an embodiment.

FIG. 2 is a section of the second connector.

FIG. 3 is a section of the first connector.

FIG. 4 is a perspective view of an uneven surface in a first mode.

FIG. 5 is a perspective view of an uneven surface in a second mode.

FIG. 6 is a perspective view of an uneven surface in a third mode.

FIG. 7 is an enlarged section showing a state where water intrusion between the inner surface of a fitting recess and the outer surface of a second housing is suppressed.

### DETAILED DESCRIPTION TO EXECUTE THE INVENTION

### Description of Embodiments of Present Disclosure

First, embodiments of the present disclosure are listed and described.

(1) The connector of the present disclosure is provided with a first housing including a fitting recess and a second housing to be fit into the fitting recess, liquid-repellent uneven surfaces being provided on an inner surface of the fitting recess and an outer surface of the second housing facing the inner surface.

According to the above configuration, since contact angles of a liquid on the uneven surfaces can be increased by a lotus effect, the intrusion of the liquid between the inner surface of the fitting recess and the outer surface of the second housing can be suppressed. As a result, even if a sealing member such as a packing is omitted, the connector can be waterproofed.

The liquid is, for example, water, oil or the like. The liquid repellency means water repellency, oil repellency or both. The liquid-repellent uneven surface means an uneven surface having liquid repellency to increase a contact angle of a liquid at least as compared to the case where this uneven surface is absent. For example, the contact angle of the liquid on the uneven surface is 90° or more.

(2) Preferably, a first terminal is arranged in the first housing, a second terminal to be connected to the first terminal is arranged in the second housing, the first terminal projects into the fitting recess from a back surface of the fitting recess, the second housing includes an insertion opening in an end surface facing the back surface of the fitting recess, the first terminal being passed through the insertion opening, and the uneven surfaces are provided on the back surface of the fitting recess and the end surface of the second housing.

According to the above configuration, since the uneven surfaces are provided at positions near a connection region of the first and second terminals, the liquid can be effectively suppressed from reaching the connection region. As a result, the connection reliability of the first and second terminals can be ensured.

(3) The first housing may include a pressing portion on a peripheral surface of the fitting recess, the pressing portion pressing the second housing in a direction to press the end surface of the second housing against the back surface of the fitting recess.

According to the above configuration, a clearance between the back surface of the fitting recess and the end surface of the second housing can be reduced, and the liquid can be more satisfactorily suppressed from reaching the connection region.

(4) A water-repellent material may be attached to the uneven surfaces.

According to the above configuration, high liquid repellency can be exhibited by a combination of the lotus effect of the uneven surfaces and a liquid-repellent effect by the water-repellent material, and the connector can be effectively waterproofed.

### DETAILS OF EMBODIMENT OF PRESENT DISCLOSURE

### Embodiment

A specific example of the present disclosure is described below with reference to the drawings. Note that the present invention is not limited to this illustration, but is represented by claims and intended to include all changes in the scope of claims and in the meaning and scope of equivalents.

A connector 10 of an embodiment is provided with a first connector 20 and a second connector 60 connectable to each other. The first connector 20 includes a first housing 21 and first terminals 22 to be mounted into the first housing 21. The second connector 60 includes a second housing 61 and second terminals 62 to be mounted into the second housing 61. Note that, in the following description, surface sides facing each other when the connection of the first and second connectors 20, 60 is started are referred to as front sides concerning a front-rear direction. A vertical direction is based on a vertical direction of each figure except FIG. 7.

(Second Connector 60)

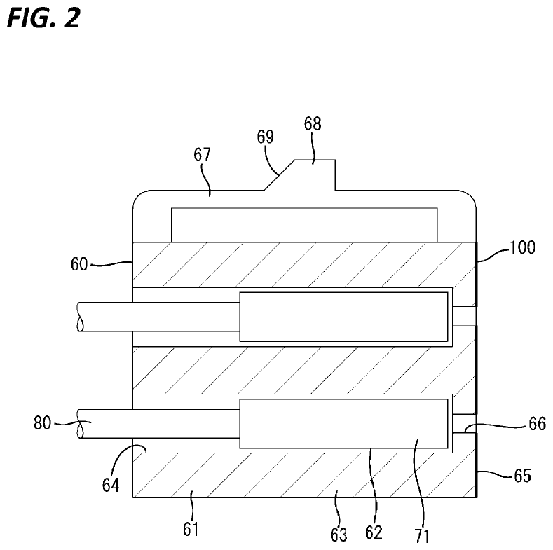

The second housing 61 is made of synthetic resin and includes, as shown in FIG. 2, a block-like housing body 63. The housing body 63 has a rectangular cross-sectional outer shape. The housing body 63 includes a plurality of cavities 64 extending in the front-rear direction. The front surface of the housing body 63 is an end surface 65 along the vertical direction and a lateral direction.

A plurality of insertion openings 66 communicating with the respective cavities 64 are provided to be open in the end surface 65 of the second housing 61. A water-repellent fine uneven surface 100 (thick-line part in FIG. 2) is provided on the end surface 65 of the second housing 61. A specific structure of the uneven surface 100 is described later.

The second housing 61 includes a lock portion 67 projecting from the upper surface of the housing body 63. The lock portion 67 extends in the front-rear direction and is in the form of a beam supported on both front and rear ends and coupled to the upper surface of the housing body 63. The lock portion 67 includes a lock projection 68 in an intermediate part in the front-rear direction. The front surface of the lock projection 68 is arranged to be upright along the vertical direction. The rear surface of the lock projection 68 is formed into an inclined surface 69 inclined forward toward a tip in a projecting direction.

The second terminal 62 is inserted and accommodated into each cavity 64 of the housing body 63 from behind.

The second terminal 62 is made of electrically conductive metal and includes a tubular body portion 71. The body portion 71 is arranged to be abutted on a rear surface opening part of the insertion opening 66 of the housing body 63. The second terminal 62 is connected to an end part of a second wire 80 behind the body portion 71. The second wire 80 is pulled out rearward from the rear surface of the housing body 63. The second wire 80 is such a normal coated wire that a conductor is surrounded around by a coating.

(First Connector 20)

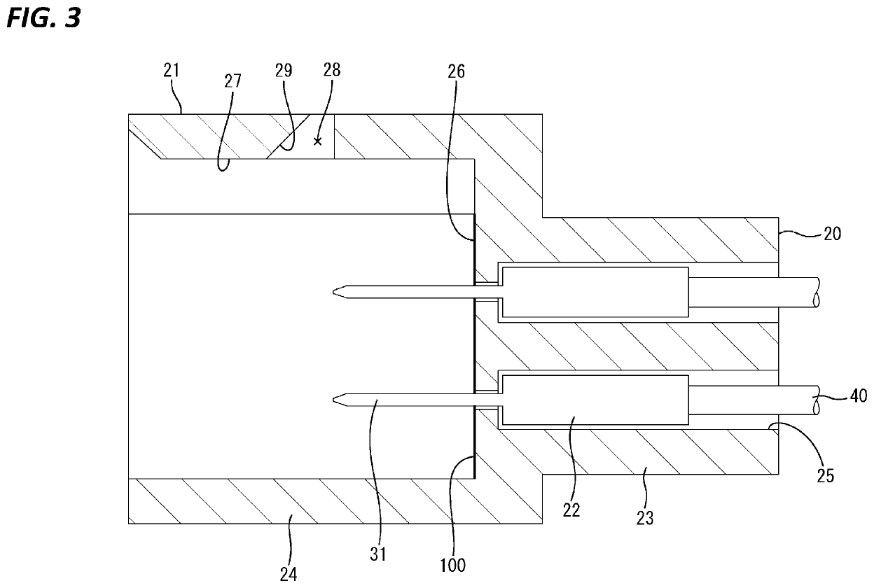

The second housing 21 is made of synthetic resin and includes, as shown in FIG. 3, a block-like terminal accommodating portion 23 and a tubular fitting recess 24 projecting forward of the terminal accommodating portion 23. The terminal accommodating portion 23 and the fitting recess 24 have a rectangular cross-sectional outer shape. The outer shape of the fitting recess 24 is one size larger than that of the terminal accommodating portion 23.

The terminal accommodating portion 23 includes a plurality of terminal accommodation chambers 25 extending in the front-rear direction. The front end of each terminal accommodation chamber 25 is open in a back surface 26 of the fitting recess 24.

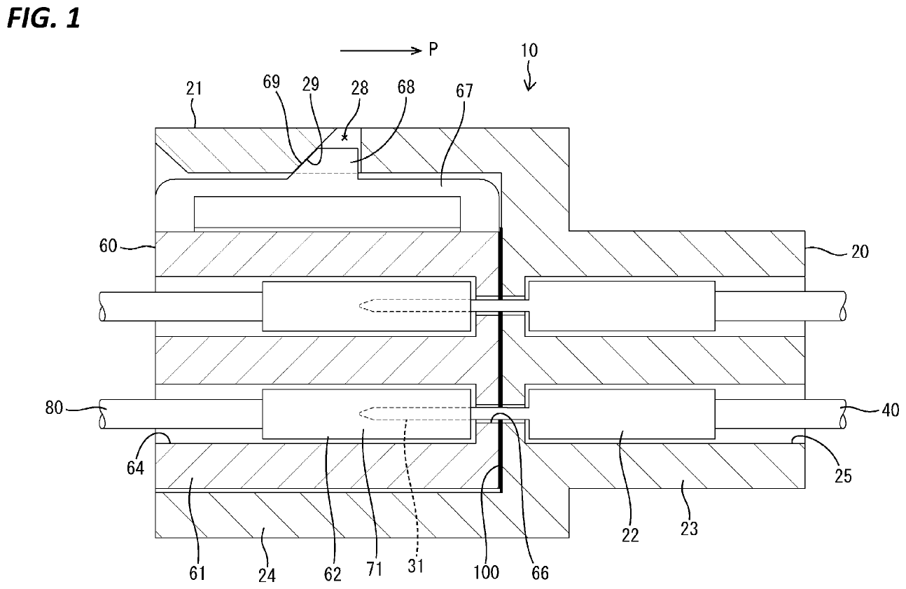

The back surface 26 of the fitting recess 24 is arranged along the vertical and lateral directions. A water-repellent fine uneven surface 100 (thick-line part in FIG. 3) is provided on the back surface 26 of the fitting recess 24, similarly to the end surface 65 of the second housing 61. The peripheral surface of the fitting recess 24 is orthogonal to an end part of the outer periphery of the back surface 26 and arranged along the front-rear direction. A lock receiving portion 28 is provided to be open in an inner upper surface 27 located on an upper side, out of the peripheral surface of the fitting recess 24. The inner rear surface of the lock receiving portion 28 is arranged along the vertical direction. The inner front surface of the lock receiving portion 28 is arranged obliquely rearward toward the upper side. As shown in FIG. 1, when the first and second housings 21, 61 are connected, the lock projection 68 of the lock portion 67 is fit into the lock receiving portion 28 of the fitting recess 24. The fitting recess 24 includes a pressing portion 29 for pressing the lock projection 68 rearward (forward when viewed from the side of the second connector 60) on the inner front surface of the lock receiving portion 28.

The first terminal 22 is inserted and accommodated into each terminal accommodation chamber 25 of the terminal accommodating portion 23 from behind.

The second terminal 21 is made of electrically conductive metal and includes a tab portion 31 projecting forward. The tab portion 31 is arranged to project into the fitting recess 24. The first terminal 22 is connected to an end part of a first wire 40 behind the tab portion 31. The first wire 40 is pulled out rearward from the rear surface of the terminal accommodating portion 23. The first wire 40 is such a normal coated wire that a conductor is surrounded around by a coating.

(Structures of Uneven Surfaces 100)

Next, the structure of the uneven surfaces 100 provided on the end surface 65 of the second housing 61 and the back surface of the fitting recess 24 are described. The uneven surface 100 has a fine uneven shape showing liquid repellency to liquids such as water and oil on the uneven surface 100. The liquid repellency by this uneven shape is generally known as a lotus effect. The lotus effect is an effect of achieving liquid repellency by increasing a contact angle of a liquid on the uneven surface 100 and forming the liquid into a shape close to a sphere.

In the case of this embodiment, the contact angle of the liquid on the uneven surface 100 is preferably 90° or more, more preferably 110° or more and particularly preferably 120° or more.

The uneven surface 100 has, for example, an uneven shape in any one of the following first to six modes or a combined mode of these.

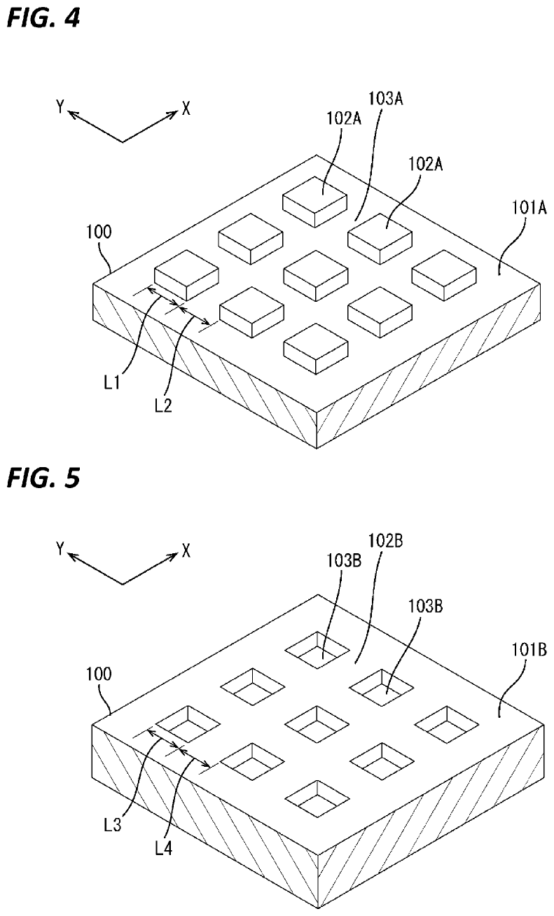

As shown in FIG. 4, in the first mode, a plurality of projections 102A are provided on a flat reference surface 101A. The respective projections 102A project in parallel at certain intervals in an X direction and a Y direction intersecting the X direction on the reference surface 101A. Each projection 102A is in the form of a flat rectangular block and has a rectangular shape, specifically a square shape, in a plan view. In the first mode, recesses 103A are formed between adjacent ones of the projections 102A on the reference surface 101A. A length L1 of each side of the projection 102A and a width L2 of the recess 103A between the adjacent projections 102A are, for example, equal to each other and preferably adjusted to 5 to 20 μm, more preferably adjusted to 10 to 20 μm.

As shown in FIG. 5, in the second mode, a plurality of recesses 103B are provided in a flat reference surface 101B. The respective recesses 103B are recessed in parallel at certain intervals in the X direction and the Y direction intersecting the X direction in the reference surface 101B. Each recess 103B is in the form of a rectangular recess and has a rectangular shape, specifically a square shape, in a plan view. In the second mode, projections 102B are formed between adjacent ones of the recesses 103B on the reference surface 101B. A length L3 of each side of the recess 103B and a width L4 of the projection 102B between the adjacent recesses 103B are, for example, equal to each other and preferably adjusted to 5 to 20 μm, more preferably adjusted to 10 to 20 μm.

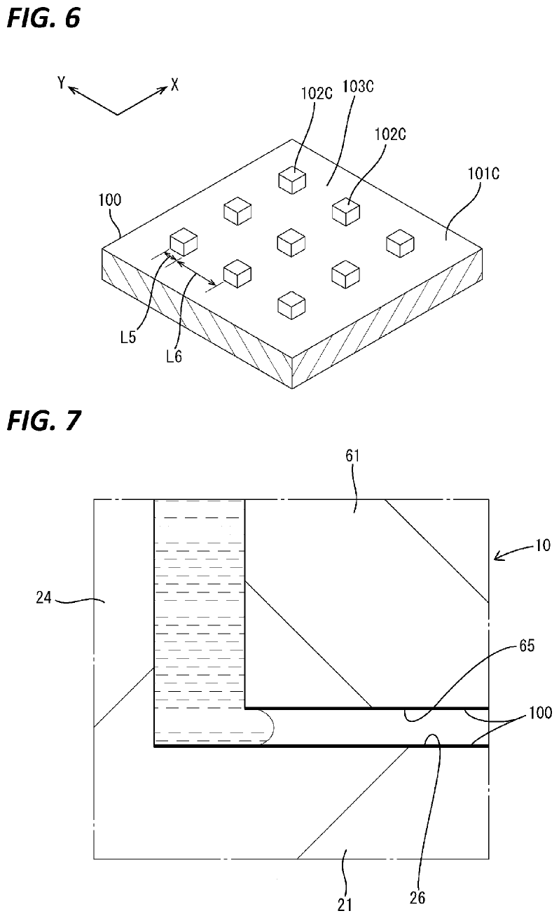

As shown in FIG. 6, in the third mode, projections 102C and recesses 103C shaped and arrayed as in the first mode are provided on a flat reference surface 101C. Unlike the first mode, a length L5 of each side of each projection 102C is smaller than a width L6 of the recess 103C between the adjacent projections 102C. For example, the length L5 of each side of each projection 102C is adjusted to 10 μm, and the width L6 of the recess 103C is adjusted to 20 μm. In the case of the third mode, a ratio of the recesses 103C and the projections 102C on the uneven surface 100 is recesses/projections>1 in area ratio.

As a result of measuring contact angles in the above first to third modes, the contact angle of water on the uneven surface 100 increased in the order of the second mode, the first mode and the third mode. That is, it was confirmed that the contact angle increased if a ratio of the recesses 103A to 103C on the uneven surface 100 increased. Particularly, in the case of the third mode, the contact angle of water on the uneven surface 100 was in a range of 120° to 150° and exceeded 130° in many cases.

The fourth and six modes are not shown, but the projections 102A to 102C of the uneven surfaces 100 in the first and third modes are changed to round projections, e.g. cylindrical projections. The fifth mode is also not shown, but the recesses 103A to 103C of the uneven surface 100 in the second mode are changed to round recesses, e.g. hemispherical recesses.

The uneven surfaces 100 in the first to sixth modes can be obtained, for example, by molding the first and second housings 21, 61 using molds imparted with uneven shapes on mold surfaces by laser processing and transferring the uneven shapes to corresponding surfaces.

In the case of this embodiment, a water-repellent material is attached to the uneven surfaces 100. The water-repellent material may be attached to the uneven surfaces 100 by immersion or application in a liquid state. For example, a known coating method may be adopted as a water-repellent material application method, but the water-repellent material may be applied to the uneven surfaces 100 by a brush or sprayed to the uneven surfaces 100. Further, by adding the water-repellent material to a resin material for molding in advance, the water-repellent material may be contained in the entire first and second housings 21, 61.

In this way, the water-repellent material may be attached to the uneven surfaces 100 and surfaces other than the uneven surfaces 100 in the first and second housings 21, 61.

Fluorine-based resins and silicone-based resins can be cited as the water-repellent material. Resins containing fluorocarbon groups such as a perfluoroalkyl group are preferable as fluorine-based resins. Fluoro Surf (registered trademark) produced by Fluoro Technology can be, for example, used as the water-repellent material.

(Waterproof Structure of Connector 10)

In connecting the first and second connectors 20, 60, the second housing 61 is inserted into the fitting recess 24 of the first housing 21. In a connection process, the lock projection 68 interferes with the upper wall of the fitting recess 24 and the lock portion 67 is deflected and deformed. When the first and second connectors 20, 60 are properly connected, the lock portion 67 is displaced in a return direction and, as shown in FIG. 1, the lock projection 68 is fit into the lock receiving portion 28. In this way, the first and second connectors 20, 60 are held in a connected state.

When the first and second connectors 20, 60 are properly connected, the tab portions 31 of the first terminals 22 enter the cavities 64 through the insertion openings 66 of the second housing 61 and are connected to the body portions 71 of the second terminals 61 arranged in the cavities 64.

Further, when the first and second connectors 20, 60 are properly connected, the inclined surface 69 of the lock projection 68 is pressed by the pressing portion 29 of the lock receiving portion 28 with the lock projection 68 fit in the lock receiving portion 28, and the second housing 61 can move in a direction to be inserted deeper into the fitting recess 24 (direction of an arrow P of FIG. 1). In this way, a clearance between the end surface 65 of the second housing 61 and the back surface 26 of the fitting recess 24 is reduced. A clearance between the respective uneven surfaces 100 formed on the end surface 65 of the second housing 61 and the back surface 26 of the fitting recess 24 is also reduced. Note that, when the first and second connectors 20, 60 are properly connected, the lock portion 67 may be kept in a deflected and deformed state without completely returning and the first and second connectors 20, 60 may be set in a state where a pre-load is applied in a connecting direction.

In the above state, even if a liquid such as water or oil should be going to intrude into the fitting recess 24, the clearance between the respective uneven surfaces 100 is narrowed and, in addition, the surface tension of the liquid increases due to the fine uneven shapes to exhibit liquid repellency by the lotus effect. Thus, the entrance of water between the respective uneven surfaces 100 can be suppressed (see FIG. 7). Moreover, since the water-repellent material is attached to the uneven surfaces 100, liquid repellency can be further enhanced.

Therefore, according to this embodiment, the connector 10 can be waterproofed even if a sealing member is omitted.

Particularly, in the case of this embodiment, the uneven surfaces 100 are provided on the end surface 65 of the second housing 61 and the back surface 26 of the fitting recess 24 and liquid repellency in a part near connection regions of the first and second terminals 22, 62 can be enhanced. Thus, the connection reliability of the first and second terminals 22, 62 can be ensured.

Further, the lock receiving portion 28 is provided in the inner upper surface 27 of the fitting recess 24 of the first housing 21, and the pressing portion 29 for pressing the second housing 61 in a direction to press the end surface 65 of the second housing 61 against the back surface 26 of the fitting recess 24 is provided on the inner front surface of the lock receiving portion 28. Thus, the clearance between the back surface 26 of the fitting recess 24 and the end surface 65 of the second housing 61 can be reduced, and the liquid can be more satisfactorily suppressed from reaching the connection regions of the first and second terminals 22, 62.

### Other Embodiments of Present Disclosure

The embodiment disclosed this time should be considered illustrative in all aspects, rather than restrictive.

Although a sealing member such as a rubber plug or packing is not provided in the connector in the case of the above embodiment, a sealing member may be provided in the connector, for example, to further improve waterproofness as another embodiment.

Although the front surface of the housing body is the end surface of the second housing in the case of the above embodiment, a front member such as a front mask or front retainer may be assembled on the front surface of the housing body and the front surface of the front member may be the end surface of the second housing as another embodiment. A liquid-repellent fine uneven surface may be provided on the front surface of the front member.

Although the pressing portion is provided in the lock receiving portion of the fitting recess in the case of the above embodiment, a pressing portion may be provided in a part different from the lock receiving portion on the inner surface of the fitting recess as another embodiment. A pressing portion may be provided in a part not involved in the locking structure.

Although the first and second terminals are respectively connected to the end parts of the first and second wires in the case of the above embodiment, at least one of the first and second terminals may be connected to a circuit board.

### LIST OF REFERENCE NUMERALS

10 . . . connector
20 . . . first connector
21 . . . first housing
22 . . . first terminal
23 . . . terminal accommodating portion
24 . . . fitting recess
25 . . . terminal accommodation chamber
26 . . . back surface
27 . . . inner upper surface
28 . . . lock receiving portion
29 . . . pressing portion
31 . . . tab portion
40 . . . first wire
60 . . . second connector
61 . . . second housing
62 . . . second terminal
63 . . . housing body
64 . . . cavity
65 . . . end surface
66 . . . insertion opening
67 . . . lock portion
68 . . . lock projection
69 . . . inclined surface
71 . . . body portion
80 . . . second wire
100 . . . uneven surface
101A, 101B, 101C . . . reference surface
102A, 102B, 102C . . . projection
103A, 103B, 103C . . . recess

1. A connector, comprising:
a first housing including a fitting recess and
a second housing to be fit into the fitting recess,
liquid-repellent uneven surfaces being provided on an inner surface of the fitting recess and an outer surface of the second housing facing the inner surface.

2. The connector of claim 1, wherein:
a first terminal is arranged in the first housing,
a second terminal to be connected to the first terminal is arranged in the second housing,
the first terminal projects into the fitting recess from a back surface of the fitting recess,
the second housing includes an insertion opening in an end surface facing the back surface of the fitting recess, the first terminal being passed through the insertion opening, and
the uneven surfaces are provided on the back surface of the fitting recess and the end surface of the second housing.

3. The connector of claim 2, wherein the first housing includes a pressing portion on a peripheral surface of the fitting recess, the pressing portion pressing the second housing in a direction to press the end surface of the second housing against the back surface of the fitting recess.

4. The connector of claim 1, wherein a water-repellent material is attached to the uneven surfaces.
